(19) United States
(12) Patent Application Publication
(10) Pub. No.: US 2019/0271995 A1
(43) Pub. Date: Sep. 5, 2019

(54) THERMOSTAT ASSEMBLY WITH POSITION SENSOR

(71) Applicant: M.A.P. MOTORAD AUTOMOTIVE PARTS LTD, Misgav (IL)

(72) Inventor: Aviram ARBEL, Hod Hasharon (IL)

(21) Appl. No.: 16/348,245

(22) PCT Filed: Nov. 1, 2017
(86) PCT No.: PCT/IL2017/051189

§ 371 Date: May 8, 2019

Related U.S. Application Data
(60) Provisional application No. 62/421,300, filed on Nov. 13, 2016.

(51) Int. Cl. G05D 23/13; F01P 7/16; G05D 23/19

(52) U.S. Cl. CPC G05D 23/1333; F01P 2007/146; G05D 23/1921; F01P 7/167

(57) ABSTRACT

A thermostat for controlling flow of a coolant fluid through an aperture, the thermostat including a temperature sensitive valve for controlling the opening and closing of the aperture, the temperature sensitive valve having: a valve body with a heat sensitive material and a displaceable pin, a lid configured to seal off the aperture, a support member, a flexible member located between the lid and the support member, and a position sensor configured to provide information indicative of the position of the temperature sensitive valve or a part thereof

### FIELD

The present disclosure generally relates to the field of thermostats and temperature controlled fluid flow.

### BACKGROUND

Thermostatic valves are regularly used for controlling the flow of fluids based on sensed temperature. In combustion engines, for example, thermostats are utilized for regulating the temperature of the engine by controlling the flow of coolant fluid from the radiator(s) to the engine. When the sensed temperature exceeds a certain value, referred to as the Start-to-Open (STO) temperature, the valve opens by distancing a valve plug from a valve seat, allowing flow of low temperature fluid, such as a coolant, from the radiator(s) to the engine, thereby lowering the engine's temperature and keeping it from overheating. Alternatively, when the sensed temperature drops below a certain level, the valve closes by introducing the valve plug to the valve seat, obstructing the flow of low temperature fluid from the radiator(s) to the engine, thereby allowing the temperature of the engine to rise and reach a desired temperature.

The valve plug is commonly actuated by a rod mechanically connected therewith. The rod is movable by the expansion and contraction of a thermally expandable material such as wax, confined in a chamber, exposed to the sensed temperature. The valve plug is movable between a ‘fully open position, at which the valve head is distanced from the valve seat, and a ‘closed position, at which the valve plug is introduced to the valve seat.

During operation, the valve may be susceptible to failures or undesired positioning behavior of the valve head between the ‘fully open position and the ‘closed position. Alternatively, it may be desirable in certain circumstances to move the valve to ‘partially open positions. Early and accurate detection of failures or undesired positions and/or the capability to accurately determine the valve head's position are important for achieving a desired behavior of the devices affected by the flow of the coolant fluid.

There is thus a need in the art for systems, devices and methods for obtaining direct information regarding the state and behavior of the thermostatic valve during operation to detect possible failures and/or to obtain information related to the behavior of the valve.

### SUMMARY

The following embodiments and aspects thereof are described and illustrated in conjunction with systems, kits and devices which are meant to be exemplary and illustrative, not limiting in scope. In various embodiments, one or more of the above-described problems have been reduced or eliminated, while other embodiments are directed to other advantages or improvements.

The present disclosure relates to systems, kits and devices for obtaining position indicators from a movable part/area of interest in a thermostatic valve by introducing a position sensor configured to measure the position of the part/area of interest during the operation of the thermostatic valve. Advantageously, obtaining position indicators to movable parts/areas of interest in the thermostatic valve may enable detection of failures or undesired behavior of the thermostatic valve and/or assist in positioning the part/area of interest according to some desired behavior.

State of the art thermostats for combustion engines typically are expected to operate as binary mechanisms: they are either closed or they are open. Engine designers have determined an optimum engine temperature by deciding on properties of a heat sensitive material such as wax, properties of a spring urging the valve to be closed, and/or additional parameters influencing the STO temperature of the valve. When the valve is open, a coolant fluid is allowed to pass from a radiator to the engine at a maximum rate of flow, predetermined by the designers as adequate to cool the engine to a given temperature within a given period of time. When the valve is closed, the fluid is blocked from passing to the engine and may circulate instead within a bypass circuit. It is assumed that, when the temperature of the cool ant fluid in the engine increases and reaches the STO, the thermostatic valve will open, letting coolant fluid reach the engine at the maximum flow rate and that, when the temperature decreases, returning to the STO, the valve will close, blocking coolant fluid from reaching the engine.

In practice though, mechanical and/or electrical failures may prevent a valve from fully opening or fully closing, leaving the valve in a partially open position. Alternatively, there may be conditions under which it is desirable for the valve to be partially open. In that state, coolant fluid is allowed to pass through the valve, from the radiator to the engine, at less than the maximum flow rate. A result may be that the engine runs at a higher than normal temperature so that fuel efficiency is increased while emissions are reduced, at the expense of possible wear and tear on engine components.

Advantageously, the thermostat disclosed herein includes a position sensor configured to determine the position of a movable part/area of interest during operation of the engine and thermostatic valve. Obtaining position information about the part/area of interest may advantageously enable detection of failures or undesired behavior of the valve and/or assist in positioning the part/area of interest according to a desired behavior. For example, notified of a failure of the valve to fully open or close, a controller could reduce engine function or shut down the engine and/or notify the user of the need for service. For example, notified of a failure of the valve to close, a controller might attempt to correct for the failure by applying mechanical and/or electrical means to cause or encourage the valve to close. For example, notified of a failure of the valve to fully open, a controller might attempt to correct for the failure by applying mechanical and/or electrical means to cause or encourage the valve to fully open. For example, a controller might be able to control the position of a valve, mechanically or electrically, and thus the rate of flow of coolant to the engine, given position information provided by a position sensor.

According to some embodiments, there is provided a thermostat for controlling flow of a coolant fluid through an aperture, the thermostat includes a temperature sensitive valve for controlling the opening and closing of the aperture, the temperature sensitive valve comprising, a valve body comprising a heat sensitive material and a displaceable pin; wherein the displaceable pin is at least partially inserted within the heat sensitive material, a lid configured to delimit the temperature sensitive valve from a top end thereof, the lid configured to seal against a valve seat when the temperature sensitive valve is closed, a support member configured to delimit the temperature sensitive valve from a bottom end thereof, and a flexible member located between the lid and the support member, wherein when the heat sensitive material is heated the displaceable pin is at least partially displaced from the valve body, thereby affecting a compression force on the flexible member, the compression force gradually displacing the temperature sensitive valve from the valve seat, thereby allowing flow of coolant fluid through the aperture, and a position sensor configured to provide information indicative of the position of the temperature sensitive valve or a part thereof.

According to some embodiments, the position sensor comprises an electromechanical device. According to some embodiments, the electromechanical device comprises an electrically conductive member and an electric circuit, the electrically conductive member mechanically connected or associated with the temperature sensitive valve or the part thereof, wherein the electric circuit is configured to allow detection of a position of the electrically conductive member.

According to some embodiments, the position of the electrically conductive member detectably affects an electric and/or magnetic field formed about the electric circuit. According to some embodiments, the external controller is electrically connected with the electric circuit, the external controller being configured to detect the position of the electrically conductive member by sensing changes in the electric and/or magnetic field. According to some embodiments, the electrically conductive member comprises a metallic or partially metallic member. According to some embodiments, the electrically conductive member is mechanically connected to the lid.

According to some embodiments, the electrically conductive member is mechanically connected to the valve body. According to some embodiments, the electrically conductive member is mechanically connected to a part of a hydraulic pressure compensation mechanism. According to some embodiments, the part of the hydraulic pressure compensation mechanism is an annular connector. According to some embodiments, the part of the hydraulic pressure compensation mechanism is an extension member.

According to some embodiments, the external controller is configured to use the information indicative of the position of the temperature sensitive valve or a part thereof to determine the position of the valve. According to some embodiments, the external controller is configured to use information indicative of the position of the temperature sensitive valve or a part thereof to detect a failure in the positioning valve. According to some embodiments, the external controller is configured to use information indicative of the position of the temperature sensitive valve or a part thereof to aid in a process of positioning valve in a desired state.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

In addition to the exemplary aspects and embodiments described above, further aspects and embodiments will become apparent by reference to the figures and by study of the following detailed descriptions.

### BRIEF DESCRIPTION OF THE DRAWINGS

Examples illustrative of embodiments are described below with reference to figures attached hereto. In the figures, identical structures, elements or parts that appear in more than one figure are generally labeled with a same numeral in all the figures in which they appear. Alternatively, elements or parts that appear in more than one figure may be labeled with different numerals in the different figures in which they appear. Dimensions of components and features shown in the figures are generally chosen for convenience and clarity of presentation and are not necessarily shown in scale. The figures are listed below.

FIG. 1A schematically shows a side view and a cross-sectional view, taken along line F-F of the side view, of an apparatus configured to control the flow of a coolant fluid from a radiator to an engine, with a position sensor, according to some embodiments;

FIG. 1B schematically shows a cross-sectional view, taken along line F-F of the top view of apparatus of FIG. 1A, in a 3D perspective, according to some embodiments;

FIG. 2A schematically shows a top view and a rear cross-sectional view, taken along line F-F of the top view, of an apparatus with a position sensor, configured to control the flow of a coolant fluid from a radiator to an engine, in a closed position, according to some embodiments;

FIG. 2B schematically shows a front cross-sectional view, taken along line F-F of the top view of apparatus of FIG. 2A, in a 3D perspective, in a closed position, according to some embodiments;

FIG. 3A schematically shows a thermostat with a valve position sensor at a closed valve position, according to some embodiments;

FIG. 3B schematically shows a thermostat with a valve position sensor at an open valve position, according to some embodiments;

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

According to some embodiments, the present disclosure provides a thermostat for controlling a temperature of an engine by controlling flow from a heat exchanger, such as a radiator, to the engine. As used herein, the terms “heat exchanger” and “radiator” may be used interchangeably to refer to an external device such as a radiator that either reduces the temperature of (cools) fluid passing through the device or exchanges fluid at one temperature for fluid at a lower temperature. The thermostat includes a valve for controlling the opening and closing of an aperture through which the coolant fluid, cooled by the radiator, can enter the thermostat and subsequently the engine.

According to some embodiments, the present disclosure provides a thermostat for controlling a temperature of an engine by controlling flow of a fluid from a heat exchanger, such as a radiator, to the engine. As used herein, the terms ‘coolant and ‘low temperature fluid may be used interchangeably to refer to a fluid provided by a heat exchanger for use by an engine, supplied at a lower temperature than a fluid circulating within the engine.

According to some embodiments, the thermostat includes a displaceable and/or thermally actuated mechanism configured to allow opening of the valve, in response to an increase in the temperature of the coolant fluid circulating in the engine. The thermostat further includes a flexible member, configured to exert pressure on the temperature responsive valve so as to resist opening of the valve and/or to force closing of the valve, when the temperature of the coolant fluid decreases. According to some embodiments, the flexible member may be a spring.

According to some embodiments, the temperature sensitive actuator includes a valve body containing a heat sensitive material and a displaceable pin. According to some embodiments, the displaceable pin may be at least partially inserted within the valve body and/or the heat sensitive material. According to some embodiments, the heat sensitive material may be a wax. As used herein, the terms ‘heat sensitive material, ‘thermally expandable material, and ‘wax may be used interchangeably to refer to a material that expands when heated and contracts when cooled, at temperatures advantageous for engine operation. According to some embodiments, the heat sensitive material may be configured to melt and expand at a temperature in the range of 90° C.-95° C., in the range of 91° C.-94° C., or in the range of 91° C.-93° C. Each possibility is a separate embodiment.

According to some embodiments, the valve may include a lid configured to delimit the valve from a top end thereof. According to some embodiments, the lid may include a flange configured to close off the aperture through which coolant fluid enters the thermostat from a heat exchanger, such as a radiator. According to some embodiments, the lid may have the form of a disc. According to some embodiments, the lid may be essentially flat. According to some embodiments, the lid may be essentially dome formed. According to some embodiments, at least part of the lid may have concave shape. According to some embodiments, the lid may have a size and shape configured to improve the flow characteristics of the coolant fluid through the aperture. According to some embodiments, the lid may be sized and shaped to ensure a gradual increase of flow of the coolant fluid through the opening of the valve as the valve is opened. According to some embodiments, the lid may be sized and shaped to prevent a burst in the flow of coolant fluid through the aperture.

According to some embodiments, the thermostat may include a valve seat. As used herein, the term “valve seat” may refer to part of the thermostat against which the temperature sensitive valve seals. As used herein, the terms “aperture” and “opening” may be interchangeably used and may refer to the gap created when the lid unseals from valve seat and may be the narrowest point through which the fluid passes into the thermostat. According to some embodiments, the valve seat may be functionally connected to the temperature sensitive valve.

According to some embodiments, the temperature sensitive valve may include a support member configured to delimit the valve from a bottom end thereof. According to some embodiments, the support member may be a lower bridge. According to some embodiments, the support member may be fixed within the thermostat, thereby providing contra force, via the flexible member positioned between the support member and the lid, to a downward movement of the lid and flexible member.

According to some embodiments, when the heat sensitive material is heated the displaceable pin may be at least partially thrust out from the valve body. According to some embodiments, when the displaceable pin is thrust out from the valve body it may encounter a niche formed within the thermostat and configured to provide contra force to the displacement of the displaceable pin, thereby affecting a compression force on the flexible member. According to some embodiments, the compression force exerted on the flexible member may gradually displace the temperature sensitive valve from the aperture, thereby allowing flow of coolant fluid from a radiator through the aperture into the engine.

According to some embodiments, when the valve seals off the aperture, the coolant fluid flows in a bypass circuitry between the engine and the thermostat.

According to some embodiments, when the valve is displaced from the seal, the coolant fluid flows through a heat exchanger, such as a radiator, where it gets cooled prior to being circulated back to the engine.

According to some embodiments, the thermostat advantageously includes a position sensor. As used herein, the term “position sensor” may refer to any element configured to measure or otherwise determine the position of a movable part/area of interest associated with or in the thermostatic valve. According to some embodiments, a position sensor may be used to determine the position of a movable part/area of interest associated with or in the thermostatic valve. According to some embodiments, a position sensor may be used to detect a failure and/or undesired positioning of a part/area of interest. According to some embodiments, a position sensor may be used as part of a mechanism for positioning a part/area of interest.

According to some embodiments, the position sensor may comprise an electromechanical device. According to some embodiments, the electromechanical device may comprise a metallic or partially metallic member configured to move with the valve lid or other valve part and an electronic sensor or electric circuit configured to allow detection of the position of the member by a controller.

According to some embodiments, the controller may be electrically connected to the electric sensor or electric circuit. According to some embodiments, the controller may induce a current in the electric sensor or electric circuit, creating an electromagnetic field about the electric sensor or electric circuit. According to some embodiments, the controller may be configured to detect movement of the metallic member by sensing disturbances or changes in the electromagnetic field about the electric sensor or electric circuit.

The term “Start to Open (STO) temperature,” as used herein, refers to a temperature range at which the thermostat valve is configured to open and to allow coolant fluid flow from the radiator to the engine. As used herein, the term “predetermined STO temperature” may refer to the default STO temperature set by the manufacturer.

According to some embodiments, the thermostat disclosed herein may be configured to facilitate elevating the STO temperature above the predetermined STO temperature of the valve, thereby increasing the engine temperature and fuel utilization. According to some embodiments, the thermostat disclosed herein may be configured to facilitate lowering the STO temperature below the predetermined STO temperature of the valve, thereby reducing wear and tear on engine components. According to some embodiments, the thermostat disclosed herein may be configured to facilitate affecting the Start-to-Open (STO) temperature of the valve after installation, during usage, by a user and/or mechanical or electrical controller.

According to some embodiments, the temperature sensitive valve may have a predetermined inherent flow characteristic, which defines the relationship between the valve opening and the flow-rate under constant pressure conditions. It is understood that the relationship between flow-rate and aperture pass area is directly proportional. However, different valve characteristics may give different valve openings for the same pass area. The physical shape of the valve and seat arrangement, sometimes referred to as the valve ‘trim’, causes a difference in valve opening between valves. According to some embodiments, the valve may be sized and shaped to improve the flow characteristics of the coolant fluid through the aperture.

According to some embodiments, the valve may be a fast opening valve. As used herein, the term “fast opening valve” may refer to a valve in which a small lift of the valve from the closed position results in a large change in flow-rate. As a non-limiting example, a valve lift of 50% may result in an orifice pass area and flow-rate of up to 90% of its maximum potential. According to some embodiments, the lid of the fast opening valve may have a shape of a flipped flat bowl. According to some embodiments, the lid of the fast opening valve may at least partially have a convex shape.

According to some embodiments, the valve may be a linear characteristic valve. As used herein, the term “linear characteristic valve” refers to a valve having a flow-rate directly proportional to the valve lift at a constant differential pressure. A linear valve achieves this by having a linear relationship between the valve lift and the orifice pass area. According to some embodiments, the lid of the linear characteristic valve may have a shape of a dome. According to some embodiments, the lid of the linear characteristic valve may at least partially have a concave shape.

According to some embodiments, the valve may be alogarithmic valve. As used herein, the term “logarithmic valve,” also sometimes known as an “equal percentage” valve, refers to one in which each increment in valve lift increases the flow-rate by a certain percentage of the previous flow. According to some embodiments, the lid of the logarithmic valve may at least partially have a concave shape and, partially, a convex shape.

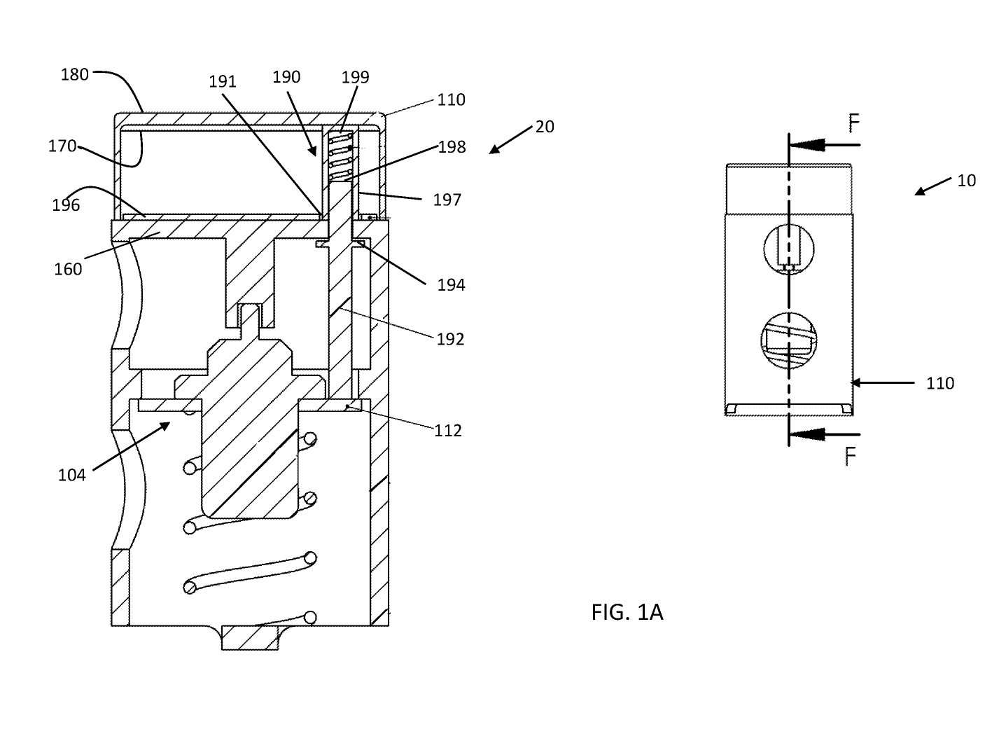

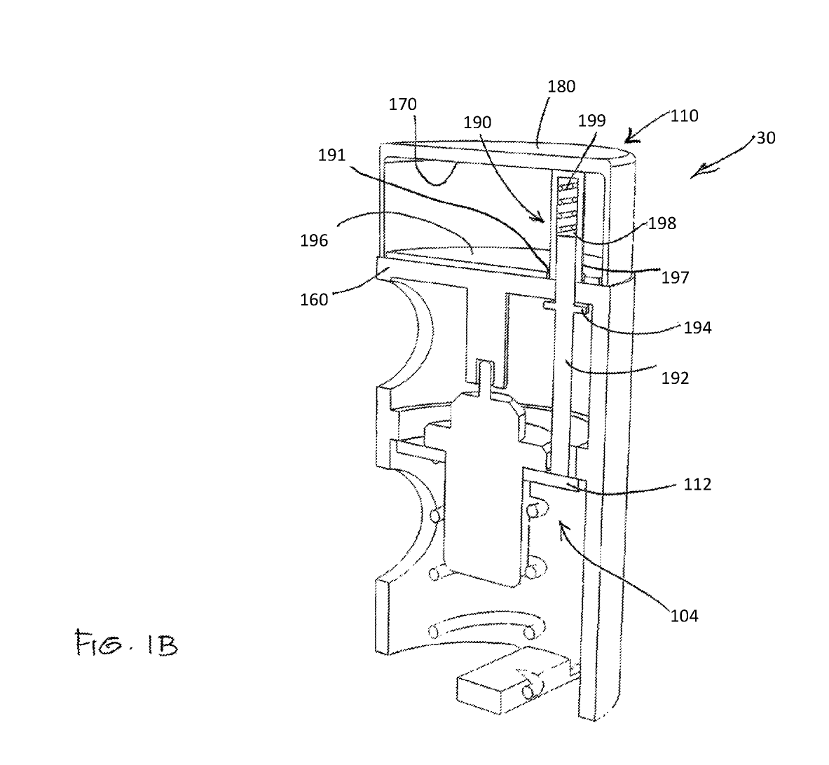

Reference is now made to FIGS. 1A & 1B. FIG. 1A schematically shows a side view 10 and a cross-sectional view 20, taken along line F-F of side view 10, of a portion of a thermostat 110, configured to control the flow of a coolant fluid from a radiator to an engine, with an exemplary position sensor, according to some embodiments. FIG. 1B schematically shows a cross-sectional view 30, taken along line F-F of the top view of portion of thermostat 110 of FIG. 1A, in a 3D perspective, according to some embodiments;

Position sensor 190 as shown, is part of thermostat 110 (only a portion of which is shown in FIGS. 1A & 1B), is associated with lid 112 of valve 104 and includes a (typically conductive, such as metallic or partially metallic) member 192, an electric circuit 196 and a controller (not shown). Member 192 is substantially cylindrical, having an appendage 194 generally perpendicular to the cylindrical body. Member 192 resides partly within channel 198 of cylindrical member 197, cylindrical member 197 formed of, or mechanically connected to, a horizontal member 160, itself formed in a body 180 of thermostat 110.

In the exemplary embodiment shown in FIGS. 1A & 1B, cylindrical member 197 is also formed of, or mechanically connected to, a roof 170 of body 180 of thermostat 110. Channel 198 has a slightly larger inner diameter than member 192, to allow up and down movement of member 192 within channel 198. Electric circuit 196 rests on, and is mechanically connected to, horizontal member 160 and is electrically connected to controller. Channel 198 and member 192 also pass through a recess 191 formed in electric circuit 196.

In some embodiments, such as those represented in FIGS. 1A & 1B, a tensioning spring 199 may be situated above member 192 within channel 198, for example when member 192 is not fixedly connected to the part/area of interest. The tensioning spring 199 is tensioned between upper inner wall of thermostat 110 at the top of channel 198 and top of member 192, urging member 192 downward and causing member 192 to be in contact with, or remain imbedded within, the part/area of interest.

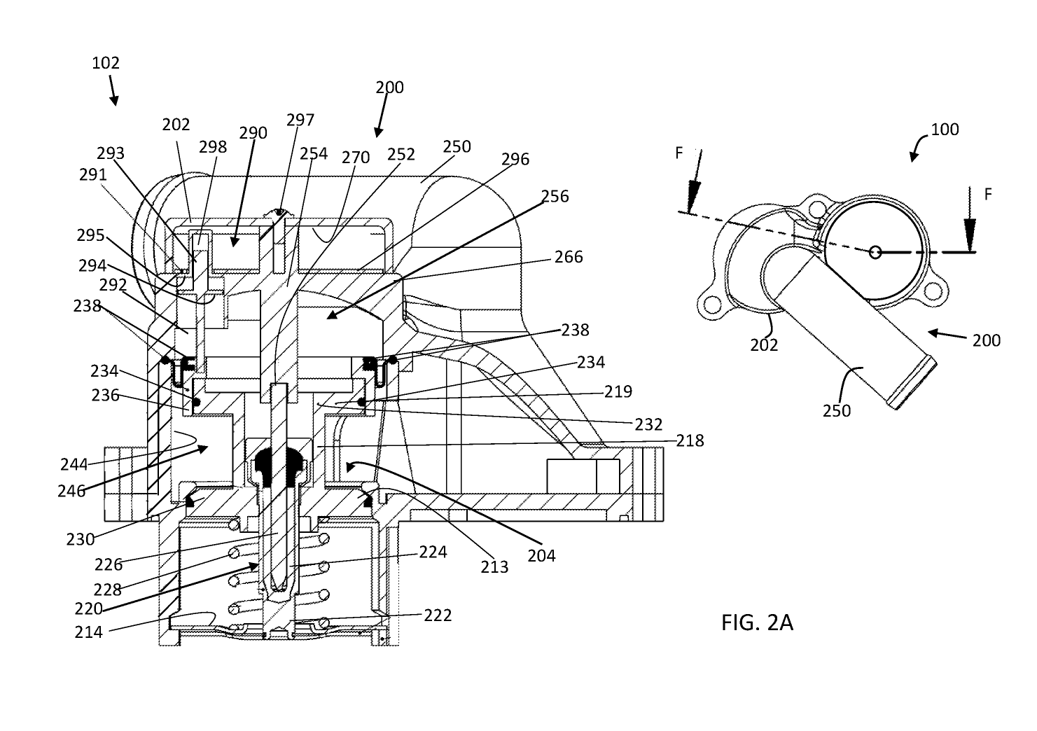

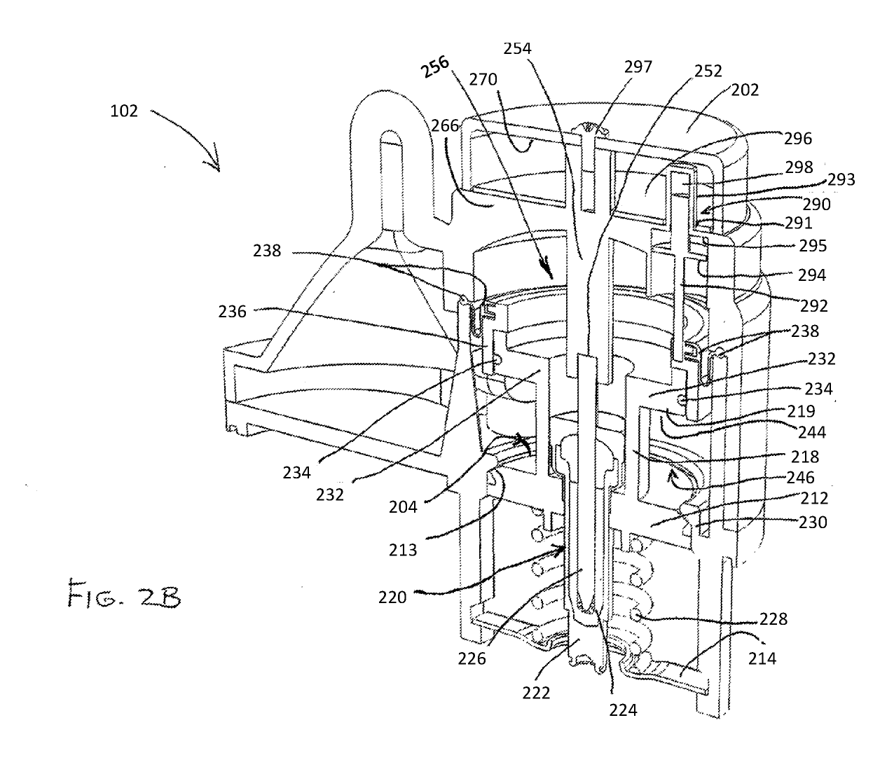

In some embodiments, such as those represented by FIGS. 1A & 1B, member 192 is configured to move with lid 112, lid 112 being part of valve 104 (exemplary valves are shown in FIGS. 2A-4 and described below). As shown, member 192 rests on top of lid 112 and tensioning spring 199 urges member 192 downward and causes member 192 to be in contact with lid 112. Alternatively, in some embodiments, member 192 may be imbedded within lid 112. In some embodiments, member 192 is fixedly connected to lid 112. In some embodiments, member 192 is not fixedly connected to lid 112.

Current applied to electric circuit 196 by the controller creates an electromagnetic field about electric circuit 196. As member 192 moves up and down, the electromagnetic field about electric circuit 196 is disturbed, particularly due to movement of appendage 194. The controller is configured to detect changes in the electromagnetic field surrounding electric circuit 196, caused by changes in the vertical position of member 192 and appendage 194, in particular. Because member 192 is mechanically associated with lid 112, vertical position of member 192 may be used as an indicator of the position of lid 112 and, by extension, the “open-ness” or ‘closed-ness” of temperature sensitive valve (not fully shown in FIG. 1).

Reference is now made to FIGS. 2A & 2B. FIG. 2A schematically shows a top view 100 and a front cross-sectional view 102, taken along line F-F of top view 100, of a thermostat 200 having a position sensor 290, in a closed mode, according to some embodiments. FIG. 2B shows a rear cross-sectional view, taken along line F-F of the top view of apparatus of FIG. 2A, in a 3D perspective, in a closed mode, according to some embodiments.

Thermostat 200 includes a main body 202 housing a valve 204, configured to block or allow flow of coolant fluid from radiator passage 250 to the engine (not shown) therethrough. Valve 204 is here depicted as a linear characteristic valve configured to optimize the flow of coolant fluid when opened; however, fast opening valves, logarithmic valves or any other type of valve may likewise be utilized and fall within the scope of this disclosure. Valve 204 includes a temperature sensitive actuator 220, a lid 212, a support member 214 and a spring 228, positioned between lid 212 and support member 214.

Temperature sensitive actuator 220 includes an actuator body 222 containing heat sensitive material 224 configured to expand above a predetermined temperature, and displaceable pin 226 partially disposed within heat sensitive material 224 and partially projecting into niche 252 formed in bridge element 254 of main body 202 of thermostat 200. Bridge element 254 is substantially cylindrical and is integrally formed on, or mechanically fixedly connected to, roof 270 of main body 202 of thermostat 200.

In the exemplary embodiment depicted in FIGS. 2A & 2B, bridge element 254 is also formed in and through horizontal member 266, horizontal member 266 being formed of main body 202 of thermostat 200.

Extension 232 is integrally formed on or, alternatively, mechanically connected to, lid 212. A flange 213 is formed on outer upper rim of lid 212 of valve 204. Extension 232 perpendicularly extends from a central part of lid 212 and has a lower hollow cylindrical portion 218 and an upper annular portion 219 extending outward from lower hollow cylindrical portion 218. Upper annular portion 219 is shaped substantially like a flat doughnut with an outer lip extending upward.

Temperature sensitive actuator 220 is disposed within hollow cylindrical portion 218 and upper annular portion 219 of extension 232 of valve 204. Spring 228, positioned between lid 212 and support member 214, is configured to force closing of valve 204, as long as a predetermined STO temperature (T1) has not been reached, as depicted in FIGS. 2A & 2B. Flange 213 is configured to create a valve seal between lid 212 and valve seat 230 when valve 204 is closed by spring 228 urging lid 212 upward, thus blocking the flow of fluid through valve 204, from radiator passage 250 to the engine (not shown).

In some embodiments, for example those represented in FIGS. 2A & 2B, thermostat 200 may further include a hydraulic pressure compensation mechanism 256. In some embodiments, thermostat 200 may not include a hydraulic pressure compensation mechanism. In embodiments having no hydraulic pressure compensation mechanism, thermostat 200 may also have no extension 232 formed on lid 212 thereof. All these possibilities are included within the scope of this disclosure.

Hydraulic pressure compensation mechanism 256 includes annular connector 236, O-ring 234, and elastic membrane 238 and makes use of upper annular portion 219 of extension 232 of lid 212. Annular connector 236 is located circumferentially to and is mechanically connected to upper annular portion 219 of extension 232 and sealed by O-ring 234. Annular connector 236 is further engagedly associated with inner wall 244 of the thermostat by elastic membrane 238. Elastic membrane 238 is substantially annular, with inner and outer lip appendages configured for engaging connector 236 and inner wall 244 of the thermostat, respectively. Together, annular connector 236, elastic membrane 238, temperature sensitive actuator 220 and inner wall 244 of the thermostat form a fluid chamber 246 above lid 212 into which may flow coolant fluid from a radiator. In embodiments having no hydraulic pressure compensation mechanism, thermostat 200 may also have no annular connector 236, O-ring 234, and elastic membrane 238.

Position sensor 290 includes a member 292 (which is typically metallic or partially metallic), an electric circuit 296, a circuit cover bolt 297 and a controller (not shown). (As opposed to embodiments represented by FIGS. 1A & 1B, embodiments represented by position sensor 290 do not include a tensioning spring.) Member 292 is substantially cylindrical, having an appendage 294 generally perpendicular to the cylindrical body. Member 292 resides within channel 298, formed within cylindrical member 293, cylindrical member 293 being formed of horizontal member 266 in main body 202 of thermostat 200. (In the exemplary embodiment shown in FIGS. 2A & 2B, cylindrical member 293 is not formed of, or mechanically connected to, roof 270 of outer body 202 of thermostat 200; (compare to exemplary embodiment of FIGS. 1A & 1B). Channel 298 has a slightly larger inner diameter than the upper portion of member 292 to allow up and down movement of member 292. Channel 298 and member 292 pass through recess 291 in electric circuit 296. Electric circuit 296 rests on, and is mechanically connected to, horizontal member 266, and is electrically connected to the controller.

In some embodiments, such as those represented by FIGS. 2A & 2B, member 292 is configured to move with annular connector 236. As shown, member 292 is imbedded within annular connector 236. Alternatively, in some embodiments, such as those represented by FIGS. 1A & 1B, member 292 may rest on top of annular connector 236. In some embodiments, member 292 is fixedly connected to annular connector 236. In some embodiments, member 292 is not fixedly connected to annular connector 236.

Current applied to electric circuit 296 by a controller creates an electromagnetic field about electric circuit 296. As member 292 moves up and down, the electromagnetic field about electric circuit 296 is disturbed, particularly due to movement of appendage 294. A controller is configured to detect changes in the electromagnetic field surrounding electric circuit 296, caused by changes in the vertical position of member 292 and appendage 294, in particular. Because annular connector 236 is mechanically associated with lid 212, via hollow cylindrical extension 232 and member 292, vertical position of member 292 may be used as an indicator of the position of lid 212 and, by extension, the “open-ness” or ‘closed-ness” of valve 204.

In some embodiments (for example, embodiments with no hydraulic pressure compensation mechanism), member 292 is configured to move with lid 212. In some embodiments, member 292 is imbedded within lid 212. Alternatively, in some embodiments, member 292 may rest on top of lid 212. In some embodiments, member 292 is fixedly connected to lid 212. In some embodiments, member 292 is not fixedly connected to lid 212.

In some embodiments, member 292 is configured to move with an element of temperature sensitive actuator 220 other than lid 212 or annular connector 236. In some embodiments, member 292 may be imbedded within that element. Alternatively, in some embodiments, member 292 may be otherwise mechanically connected or associated with that element. In some embodiments, member 292 is fixedly connected to that element. In some embodiments, member 292 is not fixedly connected to that element. In some embodiment, position sensor 290 is configured to detect movement of element member 292.

In some embodiments such as those represented in FIGS. 1A & 1B, a tensioning spring may be situated above member 292 within channel 298, for example when member 292 is not fixedly connected to the part/area of interest. The tensioning spring is tensioned between upper inner wall of thermostat 200 at top of channel 298 and top of member 292, urging member 292 downward and causing member 292 to be in contact with, or remain imbedded within, the part/area of interest. In some embodiments, such as those represented in FIGS. 2A & 2B, there is no tensioning spring.

In operation, hydraulic pressure compensation mechanism 256 functions as described herein. When fluid chamber 246 is filled with fluid, hydraulic pressure creates a downward force against lid 212 and upward force against upper annular portion 219 causing elastic membrane 238 to flex upward. This relieves at least some of the pressure directed downward against lid 212, thus at least partially compensating for the fluid pressure acting on lid 212.

In its closed operation mode (as depicted in FIGS. 2A & 2B), spring 228 is configured to force closing of temperature sensitive actuator 220, as long as fluid circulating in the engine has not reached a predetermined STO temperature (T1). Lid 212 of valve 204 is caused by spring 228 to seal against valve seat 230, thereby preventing flow of coolant fluid from radiator passage 250 to the engine (not shown), through valve 204. Additionally, member 292 is in the uppermost position when valve 204 is closed, appendage 294 being flush or nearly flush with horizontal stop 295 of thermostat body.

It is understood that, due to the pressure compensation provided by hydraulic pressure compensation mechanism 256 of the exemplary embodiment in FIGS. 2A & 2B, the force needed to cause temperature sensitive actuator 220 to seal with valve seat 230 is reduced and thus the spring constant of spring 228 may be relatively low, such as 2500 Newton/meter or below. Additionally or alternatively, the STO (T₁) may be reduced, for example to T₂ where T₂<T₁.

In some embodiments, for example those represented in FIGS. 2A & 2B, thermostat 200 may further include hydraulic pressure compensation mechanism 256. In some embodiments, thermostat 200 may not include a hydraulic pressure compensation mechanism. Both possibilities are included within the scope of this disclosure.

In some embodiments, the controller may provide/derive a general valve position information such as “open,” “partially open,” or “closed”. In some embodiments, the controller may provide/derive precise valve position information for example, in the range of an error not greater than 0.5-3 mm (e.g., 1-2 mm).

Obtaining position indicators for movable parts/areas of interest in the thermostatic valve may enable detection of failures or undesired behavior of the thermostatic valve and/or assist in positioning the part/area of interest according to some desired behavior. For example, notified of a failure of the valve to fully open or close, a controller could reduce engine function, shut down the engine and/or notify the user of the need for service. For example, notified of a failure of the valve to close, a controller might attempt to correct for the failure by applying mechanical and/or electrical means to cause or encourage the valve to close. For example, notified of a failure of the valve to fully open, a controller might attempt to correct for the failure by applying mechanical and/or electrical means to cause or encourage the valve to fully open. For example, a controller might be able to control the position of a valve, mechanically or electrically, and thus the rate of flow of coolant to the engine, given position information provided by a position sensor.

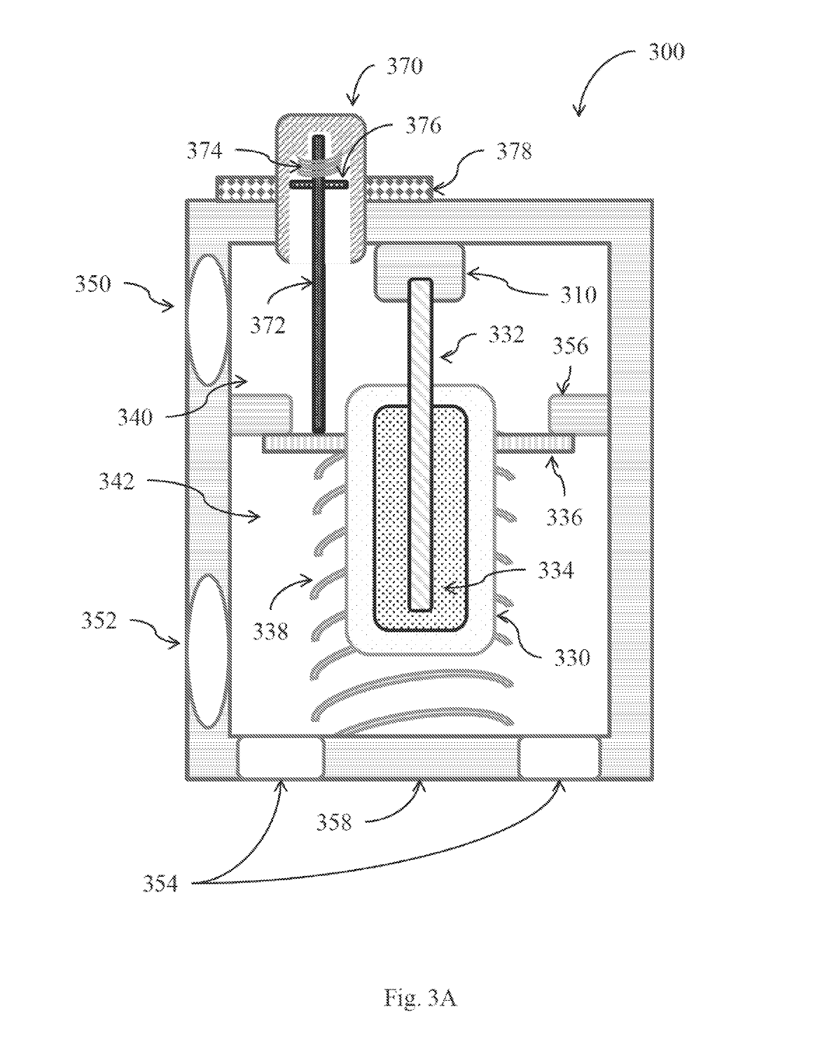

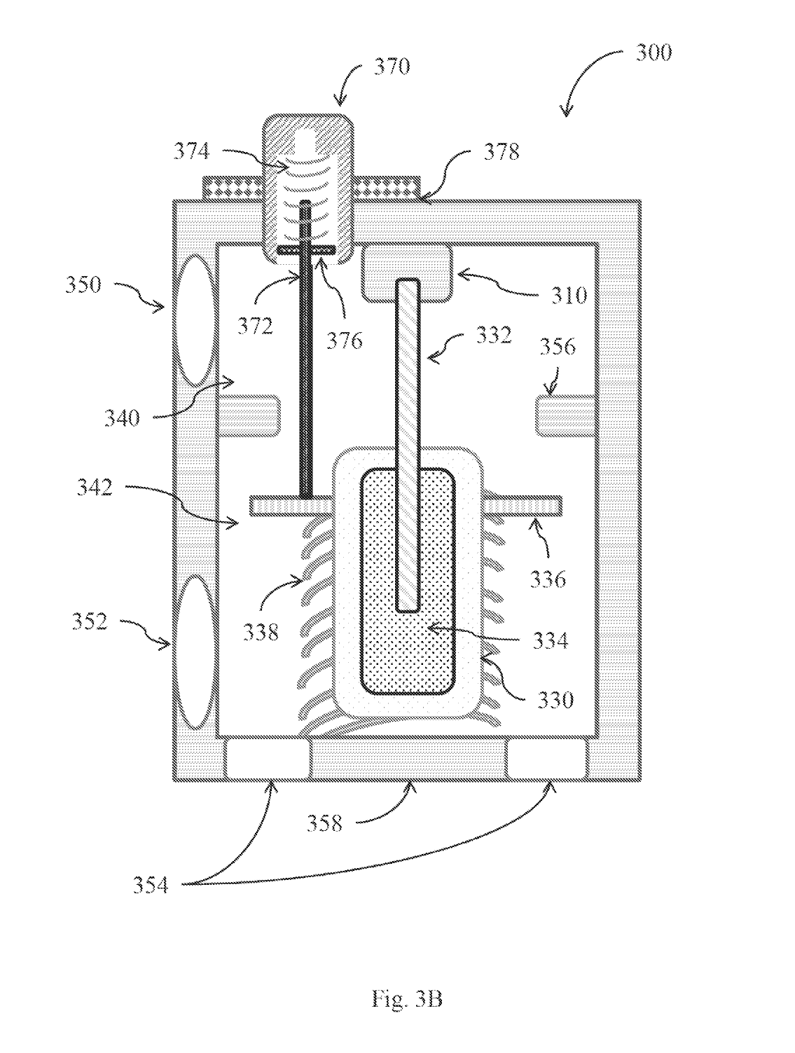

Reference is now made to FIG. 3A, which schematically illustrates a common thermostat 300, essentially similar to thermostat 110 of FIG. 1A, at a closed position. Thermostat 300 includes an engine-inlet orifice 354 configured to provide coolant fluids from the engine, an engine-outlet orifice 352 for providing coolant fluids from thermostat 300 to the engine, and a radiator-inlet orifice 350, configured to provide coolant fluids from a radiator to thermostat 300. Thermostat 300 further includes an internal aperture 356, defining a source chamber 340 which is configured to contain fluids from the radiator provided via radiator-inlet orifice 350, and a drain chamber 342, configured to contain fluids to be provided to the engine via engine-outlet orifice 352. Aperture 356 is opened and closed to facilitate or obstruct flow of fluids therethrough respectively, by a valve 336 which is movable by a thermal-actuator 330 mechanically connected thereto, between a closed position in which valve 336 is introduced and pressed against aperture 356, and an open position in which valve 336 is moved apart from aperture 356.

Thermostat 300 further includes a valve position sensor 370 comprised of an elongated member, such as displaceable pin 372, which is pressed downwards by a spring 374 to contact valve 336, following the displacement/movement thereof. Mechanically connected to (or integrated with) displaceable pin 372 is a support-member 376 on which spring 374 presses. Position sensor 370 further includes a pin-displacement sensor 378 which is configured to provide a signal indicative of the position of displaceable pin 372.

As illustrated, the temperature at drain chamber 342 is below the predetermined threshold, such that the wax 334 within thermo-actuator 330 is contracted, and pin 332 is not pushed against support frame 310, and a spring 338 presses valve 336 to close aperture 356 with support provided by lower bridge 358, and obstruct flow of fluids from source chamber 340 to drain chamber 342. As a result, displaceable pin 372 is pushed upwardly by valve 336, and pin-displacement sensor 378 provides indication of the elevated position of displaceable pin 372, which indicates that valve 336 is pressed against aperture 356, blocking the flow of fluids therethrough.

Reference is now made to FIG. 3B, which schematically illustrates a thermostat 300, essentially as disclosed in FIG. 3A, at an open position. When the temperature at drain chamber 342 reaches the predetermined threshold, wax 334 is expanded and pushes pin 332 outwardly, then support frame 310 provides mechanical contra to the extension of pin 332, pushing thermal-actuator 330 and valve 336 downwardly, affecting an opening of aperture 356, to facilitate flow of fluids from source chamber 340 to drain chamber 342. As result, displaceable pin 372 is pushed downwardly by spring 374, and pin-displacement sensor 378 provides indication of the descended position of displaceable pin 372, which indicates that valve 336 is pushed away from aperture 356, allowing the flow of fluids therethrough.

The terminology used herein is for the purpose of describing particular embodiments only and is not intended to be limiting. As used herein, the singular forms ‘a, ‘an and ‘the are intended to include the plural forms as well, unless the context clearly indicates otherwise. It will be further understood that the terms ‘comprises or ‘comprising, when used in this specification, specify the presence of stated features, integers, steps, operations, elements, or components, but do not preclude or rule out the presence or addition of one or more other features, integers, steps, operations, elements, components, or groups thereof.

While a number of exemplary aspects and embodiments have been discussed above, those of skill in the art will recognize certain modifications, additions and sub-combinations thereof. It is therefore intended that the following appended claims and claims hereafter introduced be interpreted to include all such modifications, additions and sub-combinations as are within their true spirit and scope.

What is claimed is:

1. A thermostat for controlling flow of a coolant fluid through an aperture, the thermostat comprising:
a temperature sensitive valve for controlling the opening and closing of the aperture, said temperature sensitive valve comprising:
a valve body comprising a heat sensitive material and a displaceable pin; wherein said displaceable pin is at least partially inserted within said heat sensitive material;
a lid configured to delimit the temperature sensitive valve from a top end thereof, said lid configured to seal against a valve seat when said temperature sensitive valve is closed;
a support member configured to delimit the temperature sensitive valve from a bottom end thereof; and
a flexible member located between said lid and said support member;
wherein when said heat sensitive material is heated, said displaceable pin is at least partially displaced from said valve body, thereby affecting a compression force on said flexible member, said compression force gradually displacing said temperature sensitive valve from said valve seat, thereby allowing flow of coolant fluid through said aperture; and
a position sensor configured to provide information indicative of the position of said temperature sensitive valve or a part thereof.

2. The thermostat of claim 1, wherein said position sensor comprises an electromechanical device.

3. The thermostat of claim 2, wherein said electromechanical device comprises an electrically conductive member and an electric circuit, said electrically conductive member mechanically connected or associated with said temperature sensitive valve or said part thereof, wherein said electric circuit is configured to allow detection of a position of said electrically conductive member.

4. The thermostat of claim 3, wherein the position of said electrically conductive member detectably affects an electric and/or magnetic field formed about said electric circuit

5. The thermostat of claim 4, wherein an external controller is electrically connected with said electric circuit, said external controller being configured to detect said position of said electrically conductive member by sensing changes in said electric and/or magnetic field.

6. The thermostat of claim 3, wherein said electrically conductive member comprises a metallic or partially metallic member.

7. The thermostat of claim 3, wherein said electrically conductive member is mechanically connected to said lid.

8. The thermostat of claim 3, wherein said electrically conductive member is mechanically connected to said valve body.

9. The thermostat of claim 3, wherein said electrically conductive member is mechanically connected to a part of hydraulic pressure compensation mechanism

10. The thermostat of claim 9, wherein said part of said hydraulic pressure compensation mechanism is an annular connector.

11. The thermostat of claim 9, wherein said part of said hydraulic pressure compensation mechanism is an extension member.

12. The thermostat of claim 5, wherein said external controller is configured to use said information indicative of the position of said temperature sensitive valve or a part thereof to determine the position of the valve.

13. The thermostat of claim 5, wherein said external controller is configured to use information indicative of the position of said temperature sensitive valve or a part thereof to detect a failure in positioning the valve.

14. The thermostat of claim 5, wherein said external controller is configured to use information indicative of the position of said temperature sensitive valve or a part thereof to aid in a process of positioning the valve in a desired state.
